(19) United States
(12) Patent Application Publication
(10) Pub. No.: US 2017/0096355 A1
(43) Pub. Date: Apr. 6, 2017

(54) PROCESS AND SYSTEM FOR WELL WATER TREATMENT

(71) Applicant: SAAD A Al-Jlil, RIYADH (SA)

(72) Inventor: SAAD A Al-Jlil, RIYADH (SA)

(73) Assignee: King Abdulaziz City for Science and Technology (KACST), RIYADH (SA)

(21) Appl. No.: 14/875,695

(22) Filed: Oct. 6, 2015

(51) Int. Cl. C02F 9/00; C02F 1/44; B01D 61/36; C02F 1/52; B01D 3/10; B01D 53/04; C02F 1/06; C02F 1/28

(52) U.S. Cl. CPC C02F 9/00; C02F 1/06; C02F 1/447; C02F 1/28; C02F 1/52; B01D 3/10; B01D 53/04; B01D 61/364; C02F 2001/5218; C02F 2103/10

(57) ABSTRACT

There is provided a process for treating well water to produce drinking water. The process combines a vacuum tank process, an adsorption-desorption process, a heat-exchanger process, a membrane distillation-crystallization process. The process allows for some level of efficiency with regard to energy consumption and operational and maintenance costs.

### FIELD OF TECHNOLOGY

This disclosure relates generally to the treatment of well water for the production of drinking water. More specifically, this disclosure relates to a well water treatment process that combines adsorption-desorption, membrane distillation and crystallization processes. The process of this disclosure may be operated with no external energy source, in the case of a deep well.

### BACKGROUND

Rural and urban developments as well as increase in population lead to requirements for more good quality water, not only for human consumption but also for other beneficial activities. Water shortage is becoming a global issue, especially in the arid and semi-arid regions of the world. According to a report from the United Nations (1999), water shortage, besides global warming, is considered the most worrying problem for the millennium. In view of this, processes such as brackish water desalination for the production of safe drinking water have gained momentum. Conventional water desalination processes such as reverse osmosis (RO) and other similar processes suffer from many disadvantages. For example, these processes are rather expensive to be implemented in poor countries. RO is a pressure driven process which is highly susceptible to fouling. The cost effectiveness of RO plants is strongly dependent on the cost of energy resources such as oil and gas. These facts have urged researchers to look into the alternative approaches.

Deep wells are generally wells having depths of up to 2500 m. Typically, water from the deep wells is hot, with temperatures ranging between about 70-80° C. Deep wells are found in many countries around the world. Various alternative approaches for producing good quality drinking water use water from deep wells. These approaches aim at minimizing energy, operational and maintenance costs. For example, the operating pressure in a RO process is between 40-60 bars. Alternative approaches aim at reducing this pressure. Up until today, the inventor is aware of no brackish water desalination process that has acceptable energy efficientcy and that is cost-effective.

In many countries, groundwater is the main source for drinking water. As indicated above, deep well water is hot (temperature of about 70-80° C.) and has a pH of about 7.98. Accordingly, deep well water needs to be cooled. Cooling towers are generally used. Typically, water is pumped into the cooling tower using a pump. Water is collected into tanks before entering the cooling tower. The cooling process may involve water in the form of a spray, water moving as a cascade on horizontal barriers, or water falling slowly as droplets. Subsequent to this process, the temperature of the water is reduced to about 30° C. Cooling towers generally have a cooling capacity of 150 m³ hr⁻¹. Also, generally deep well water contains various types of dissolved chemicals such as salts and salt ions including iron (Fe), manganese (Mn), calcium (Ca) and magnesium (Mg). Moreover, deep well water contains other solids such as silica from aquifer rocks.

More specifically regarding the cooling process, deep well water is pumped into a cooler and aerated, which results in the precipitation of ferrous/ferric oxide. Water from the cooler is then passed through a sand filter to remove any suspended solids. The purified water from the sand filter is further fed to a treatment chamber for treatment with lime (Ca(OH)₂), soda (Na₂CO₃) and sodium aluminate (Na₄Al₂O₅) to remove hardness and silicates. This chemical treatment results in the precipitation of Ca and Mg salts such as CaCO₃, MgCO₃ and a complex of sodium-aluminum-silicate. The solubility constant of these salts is very low, thus the salts settle at the bottom of the chamber in the form of a precipitate (solid waste). The purified water from the treatment chamber is then submitted to a RO process to desalinate the water.

The RO process removes various types of large molecules and ions from the solution, by applying pressure to the solution when it is on one side of a selective membrane. The result is that the solute is retained on the pressurized side of the membrane and a relatively pure solution is allowed to pass to the other side of the membrane. To be considered “selective”, the membrane should not allow large molecules or ions to pass through the pores (holes), but should allow smaller components of the solution (such as the solvent) to pass freely. RO is most commonly known for its use in the production of drinking water from seawater by removing salts and other substances from the seawater. RO process is the reverse of normal osmosis process, in which a solvent naturally moves from an area of low solute concentration, through a membrane, to an area of high solute concentration. A relatively pure solution moves from one side of the membrane to the other to equalize solute concentrations, thus generating a pressure which is called the “osmotic pressure”. Applying an external pressure to reverse the natural flow of the pure solution leads to the RO process.

The RO process is similar to membrane filtration. However, there are key differences between the two processes. The predominant removal mechanism in membrane filtration is straining, or size exclusion; accordingly, membrane filtration may theoretically achieve perfect exclusion of particles regardless of operational parameters such as influent pressure and concentration. RO, however, involves a diffusive mechanism so that separation efficiency is dependent on solute concentration, pressure and water flux rate.

The following are the characteristics of RO: 1—operating pressure is between 40-60 bar; 2—pore size is <0.002 μm; and 3—membrane material(s) are typically either cellulose acetate or polysulfone coated with aromatic polyamides.

Configuration of a whole well water treatment plant for the production of drinking water known in the art, for example in Riyadh city, Saudi Arabia is illustrated in FIG. 1. Typically, water at a temperature of about 70-80° C. is pumped from a well 112 into a cooler 114. Then, it is submitted to sand filters 116. Water exiting the filters is collected into a tank 118 which is equipped with precipitators. The tank is equipped with a number of material storages 120, 122, 124 such that materials such as lime, sodium aluminate and soda may be supplied to the tank. Solid material is precipitated at the bottom of the tank and is collected in the form of solid waste 126. Water exiting the tank is submitted to RO process in a RO unit 128, and drinking water is collected into a drinking water tank 150.

There is still a need for simple, energy-efficient and cost-effective processes for treating well water to produce good quality drinking water.

### SUMMARY

This disclosure relates to a process for treating well water to produce drinking water. The process combines a vacuum tank process, an adsorption-desorption process, a heat-exchanger process, a membrane distillation-crystallization process. The process of this disclosure allows for some level of efficiency with regard to energy consumption and operational and maintenance costs. Indeed, the required pressure is about 1 bar, which is low comparing to pressures of about 40-60 bars required in reverse osmosis. In the case of a deep well, the process is operated with no external energy source.

Several embodiments for the process and associated system of this disclosure are outlined below.

In an embodiment, this disclosure relates to a process for treating well water, comprising: (a) submitting well water to a vacuum tank process to obtain water vapor and brine; (b) submitting the water vapor to adsorption and desorption processes in an adsorption-desorption unit having one or more columns; (c) submitting the water vapor from step (b) to a heat-exchange process to obtain the drinking water and brine, wherein heat is exchanged between the water vapor and brine obtained from step (a); and (d) submitting brine obtained from steps (a) and (c) to a membrane distillation-crystallization process to obtain drinking water and a solid waste, the drinking water being combined to the drinking water obtained at step (c).

In one embodiment, the process further comprises a step of (al) adding an anti-scalant to water prior to step (a).

In one embodiment, the well may be a deep well and the well water at step (a) has a temperature of about 60 to 90° C.; or the well may be a regular well and the well water is heated prior to step (a), optionally heating is performed with solar energy.

In one embodiment, at step (b), the water vapor is adsorbed on a hydrophilic adsorbent. Also, step (b) may comprise simultaneously sparging air during the adsorption process.

In one embodiment, at step (b), the water vapor is desorbed from a hydrophilic adsorbent by passing the well water into coils of the column, and the process comprises the further step of (b1) mixing the water from the coils with the well water; optionally the water from the coil is heated to about 60 to 90° C. prior to being mixed with the well water, and optionally heating is performed with solar energy.

In one embodiment, step (d) comprises contacting one side of a porous hydrophobic membrane with brine, while contacting the other side of the membrane with water at room temperature which is tap water or the drinking water obtained at steps (c) and (d).

In one embodiment, the process further comprises a step of (e) submitting the drinking water to a cooling step.

In one embodiment, step (b) is performed simultaneously in two or more columns of the adsorption-desorption unit, the water vapor obtained from the units being combined prior to step (c).

In another embodiment, this disclosure relates to a process for treating deep well water, comprising: (a) pumping water from a deep well and submitting the water to a vacuum tank process to obtain water vapor and brine; (b) submitting the water vapor to adsorption and desorption processes in an adsorption-desorption unit having one or more column comprising a hydrophilic adsorbent and coils, wherein the water vapor is adsorbed on a hydrophilic adsorbent and the water vapor is desorbed from the hydrophilic adsorbent by passing the well water into the coils; (c) submitting the water vapor from step (b) to a heat-exchange process to obtain the drinking water and brine, wherein heat is exchanged between the water vapor and brine obtained from step (a); (d) submitting brine obtained from steps (a) and (c) to a membrane distillation process to obtain drinking water and salt water, the drinking water being combined to the drinking water obtained from step (c), wherein one side of a porous hydrophobic membrane is contacted with brine, while the other side is contacted with water at room temperature which is tap water or the drinking water obtained from steps (c) and (d); and (e) submitting the salt water to a crystallization step to obtain a solid waste and water vapor, and the water vapor is mixed with the water vapor obtained from step (b).

In yet another embodiment, this disclosure relates to a system for well water treatment, comprising: a vacuum tank; an adsorption-desorption unit having one or more columns; a heat-exchanger; and a membrane distillation-crystallization unit, wherein the vacuum tank is operably connected to a well such that water from the well at a temperature of about 60 to 90° C. fed thereto yields brine and water vapor which is fed to the adsorption-desorption unit, and the water vapor exiting the adsorption-desorption unit is fed to the heat-exchanger wherein heat is exchanged between the water vapor and brine from the vacuum tank yielding a condensate drinking water which is collected in a collector tank and brine which is fed to the membrane distillation-crystallization unit to yield a solid salt waste and water vapor which is fed back to the heat-exchanger.

Other features will be apparent from the accompanying drawings and from the detailed description that follows.

### BRIEF DESCRIPTION OF DRAWINGS

Example embodiments are illustrated by way of example and not limitation in the figures of the accompanying drawings, in which like references indicate similar elements and in which:

FIG. 1 outlines a well water treatment process known in the art, for example in Riyadh city, Saudi Arabia.

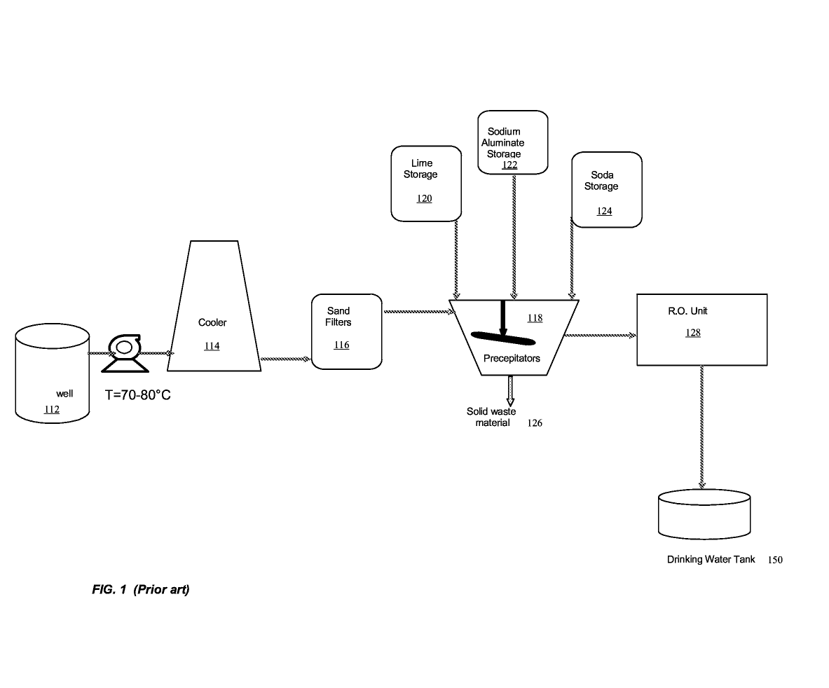

FIG. 2 outlines an embodiment of the well water treatment process of this disclosure.

FIG. 3 outlines an embodiment of the well water treatment process of this disclosure.

Other features of the present embodiments will be apparent from the accompanying drawings and from the detailed description that follows.

### DETAILED DESCRIPTION

In order to provide a clear and consistent understanding of the terms used in the present disclosure, a number of definitions are provided below. Moreover, unless defined otherwise, all technical and scientific terms as used herein have the same meaning as commonly understood to one of ordinary skill in the art to which this disclosure pertains.

The use of the word “a” or “an” when used in conjunction with the term “comprising” in the claims and/or the description may mean “one”, but it is also consistent with the meaning of “one or more”, “at least one”, and “one or more than one”. Similarly, the word “another” may mean at least a second or more.

As used herein, the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

As used herein, the term “about” is used to indicate that a value includes an inherent variation of error for the device or the method being employed to determine the value.

The disclosure is drawn to a process for treating well water to produce drinking water. The process combines a vacuum tank process, an adsorption-desorption process, a heat-exchanger process, a membrane distillation-crystallization process. The process of this disclosure allows for some level of efficiency with regard to energy consumption and operational and maintenance costs. Indeed, the required pressure is about 1 bar, which is low comparing to pressures of about 40-60 bars required in reverse osmosis. In the case of a deep well, the process is operated with no external energy source.

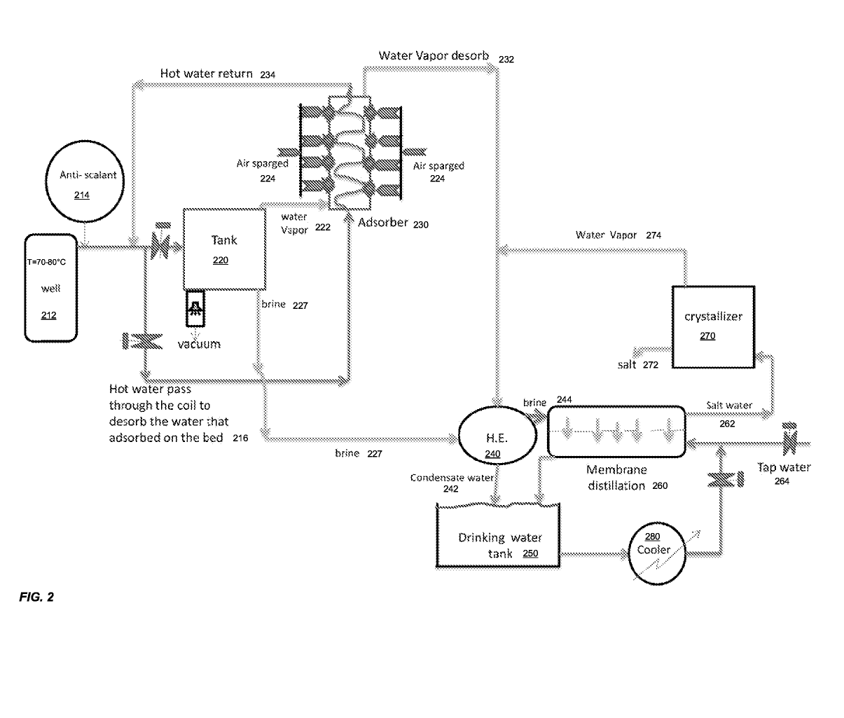

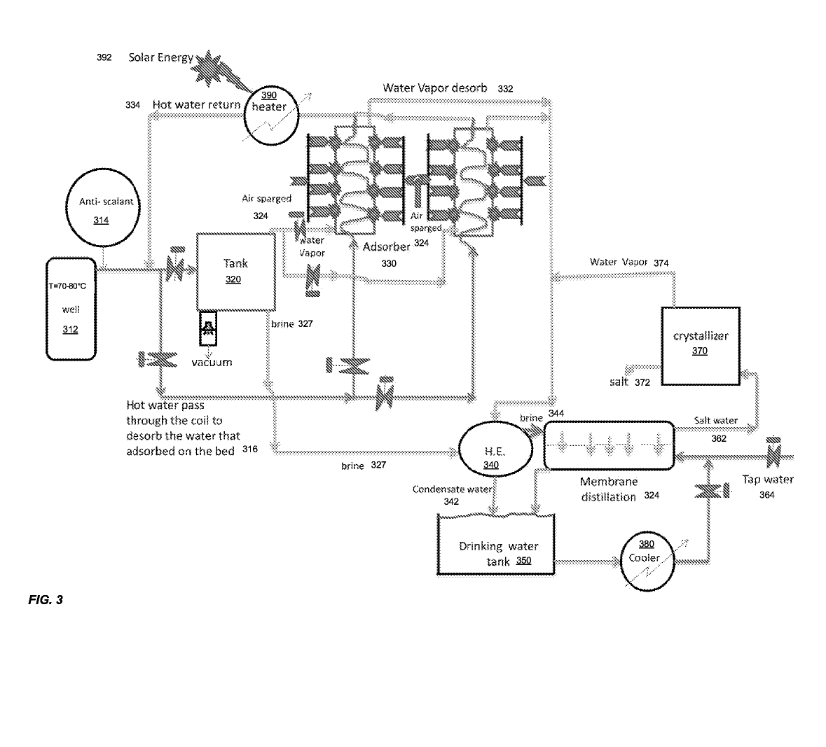

The process of this disclosure is a brackish water desalination process. The process comprises the following three phases: 1—a vacuum tank process conducted in a vacuum tank, 2—adsorption and desorption processes conducted in an adsorption-desorption unit, and 3—a membrane-distillation process followed by a crystallization process conducted in a membrane distillation-crystallization system. Details on each of the three phases are outlined below in relation to a deep well and referring to FIG. 2 and FIG. 3.

### Vacuum Tank

Typically, a vacuum tank process is a process of causing the pressure http://en.wikipedia.org/wiki/Pressure in a water-filled container to be reduced below the vapor pressure http://en.wikipedia.org/wiki/Vapor_pressure of the water, thus causing water to evaporate at a lower temperature than normal. In this disclosure, the interior pressure of the tank is reduced below atmospheric pressure. This reduces the boiling point of water to be evaporated. The hot well water (temperature of about 70-80° C.) is pumped into the vacuum tank 216, 316 resulting in the evaporation of water. This process also yields brine. An anti-scalant material 214, 314 is added to water prior to its introduction into the vacuum tank. The water vapor exiting the vacuum tank 222, 322 is directed to the adsorption-desorption unit 230, 330.

### Adsorption-Desorption Unit

The adsorption-desorption unit 230, 330 may comprise one column or more. Each column is continually switched between adsorption process and desorption process.

During the adsorption process, the water vapor from the vacuum tank 222, 322 is adsorbed on a hydrophilic adsorbent which may be a nano-bentonite clay or a clay-carbon nanocomposite or a zeolite-carbon nanocomposite or a chitosan-clay nanocomposite. Also during the adsorption process, air is sparged (pushed) 224, 324 to the adsorbent bed inside the column. This is done using an air distributer to enhance the mass transfer of the water vapor to the adsorbent bed. The adsorption rate of the water vapor on the hydrophilic adsorbent bed is thus enhanced. Air may be used at its normal temperature. After a period of time, for example 10 minutes, the adsorbent bed is saturated. The adsorption process may be switched to another column and the process continues. Meanwhile, desorption process is started on the first column.

Desorption is the reverse of adsorption. Typically, desorption is a process whereby a substance (water vapor) is released from the surface of the adsorbent bed in the column (http://en.wikipedia.org/wiki/Phenomenon). The desorption process is operated by passing the hot water from the well through coils inside the column 216, 316. Hot water introduced in the coils includes and anti-scalant material. Heat from the hot water inside the coils is transferred to the bed column and desorbs water that is adsorbed on the adsorbent bed. Water is released in the form of vapor 232, 332 and leaves the column. The desorption process cleans the adsorbent bed and regenerates the adsorbent. Water introduced through coils inside the column 216, 316 for the desorption process exits the absorber unit and is returned in the system 234, 334. Optionally this water is heated before being fed to the system. Heating may be performed using a heater 390 which may be solar energy 392 or any suitable energy providing means.

This water vapor is directed to a heat-exchanger (HE) 240, 340 to condense 242, 342 yielding drinking water which is collected into a drinking water tank 250, 350. The drinking water may further be fed to a cooler 280, 380 for cooling. Heat exchange is produced between the water vapor 232, 332 and brine 227, 327 coming from the vacuum tank. More specifically, the water vapor 232, 332 transfers its energy to brine 227, 327. The temperature of brine is thus increased. This hot brine 244, 344 is submitted to membrane distillation 260, 360 for further desalination.

As indicated above, an anti-scalant material 214, 314 is added to the well water prior to introduction in the coils. This prevents scaling on the surface the coils in the columns of the adsorption-desorption unit. Such material may be for example a Hf anti-scalant material, a Epson-Hf anti-scalant material or an acid such as H₂SO₄.

When the adsorption-desorption unit 230, 330 has two or more columns, for example as illustrated in FIG. 3, the adsorption and desorption processes continue without interruption as the two or more columns are continually switched between adsorption and desorption.

### Membrane Distillation-Crystallization (MDC)

Membrane distillation-crystallization is a combination of membrane distillation (MD) process and crystallization process. The membrane-distillation yields drinking water 250, 350 and a concentrated salt water 262, 362 which is directed to a crystallizer 270, 370 for the crystallization process where solids 272, 372 are recovered and water vapor 274, 374 is liberated. The water vapor 274, 374 may be fed back to the heat-exchanger 240, 340. And the solids from the crystallizer (salts) 272, 372 may be used as a new adsorbent to adsorb heavy metals from waste water. Accordingly, in the process of this disclosure, use of a crystallizer leads to no concentrated water being rejected.

The membrane distillation process involves a distillation membrane, which may be a porous hydrophobic membrane such as a micro-porous hydrophobic hollow fiber membrane. Such membrane allows for the use of a pressure equal to the natural atmospheric pressure (i.e., equal to 1 bar). An example of such porous hydrophobic membrane is poly(vinylidene fluoride) (PVDF) membrane which is a commercially available. This polymer presents several properties that are attractive for membrane distillation application. For example, contrary to other fluoro-polymers since PVDF gives rise to smooth surfaces. This reduces the formation of bio-organic films and bacterial colonies. Also, PVDF is resistant to a wide variety of corrosive chemicals and organic solvents, including strong acids, chlorine, caustic solutions and strong oxidizing agents. The mechanical properties of PVDF remain good in a wide range of temperatures. Moreover, PVDF shows a high durability in ambient and sub-ambient conditions.

In embodiments of this disclosure, the porous hydrophobic membrane may have a pore size of about 0.002-4 μm. Also, in order to enhance the hydrophobicity of the PVDF membrane, a polyvinylpyrrolidone may be added. Moreover, a micro-size membrane allows for an easy maintenance and backwash. Adoption of a proper feed flow also helps in the maintenance of the membrane.

Other suitable porous hydrophobic membranes may include for example polytetrafluoroethylene (PTFE), trimethylchlorosilane (TMS) and polydimethylsiloxane (PDMS).

In the membrane distillation process, the liquid feed is hot (temperature of about 70-80° C.) and is brought into contact with one side of the hydrophobic membrane. On the membrane permeate side, tap water 264, 364 is provided, only at the beginning of the run (suggested at room temperature 25° C.), in direct contact with the permeate side of the membrane to maintain the mass transfer driving force, which is the water vapor partial pressure across the membrane. This configuration is known as the direct contact membrane distillation (DCMD). After that, drinking water that is collected in the drinking water tank will be circulated in counter-current. This makes the system more cost-efficient. Circulation of the drinking water is made in a continuous manner at a fixed temperature of about 25° C.

The operating temperatures in the process of this disclosure may be maintained at a temperature as low as 50° C. and the operating pressure is around the natural atmospheric pressure (equal to about 1 bar). Also, in the case of a deep well, the energy source is the natural energy source from the water. Accordingly, the process is energy-efficient and cost effective. In embodiments of the disclosure where an external source of energy is required, for example for heating water from the coils of the adsorption-desorption unit prior to re-entering the system or for example for heating the well water when water is being pumped from a regular well, solar energy is used. Moreover, membrane distillation is generally known to present advantages such as low operating pressures, use of modest temperatures, potentially complete retention of nonvolatile solutes and high purity of permeate water (drinking water). In addition, use of a heat-exchanger (instead of a condenser) enhances the cost-efficiency of the process of this disclosure. The process of this disclosure may be implemented in a plant or system with a piping that is made thin, since the required pressure is low. Accordingly, the production cost of the plant is also low comparing to a plant for RO. The process of this disclosure does not require use of cartridge filter, nanofilter, high pressure pumps or the like. Accordingly, the operation cost is low. In the case of a deep well, corrosion is avoided as the pH of the well water is about 7.98.

### Example 1

Referring to FIG. 2, water from the deep well 212 (temperature of about 70-80° C.) and wherein an anti-scalant material 214 is added, is pumped into the vacuum tank 220. Then, water vapor 222 is passed to the adsorption-desorption unit 230 to adsorb the water vapor on the hydrophilic adsorbent bed. In the columns of the adsorption desorption unit 230, air is sparged (passed) 224 to the adsorbent bed to enhance the mass transfer of the water vapor to the adsorbent, hence, to enhance the adsorption rate of the water vapor on the adsorbent bed. This process continues for a period of time, for example 10 minutes, or up to the saturation of the adsorbent bed, then the bed is switched to be desorber by passing hot well water through the coils inside the columns 216 to transfer the heat to the adsorbent bed to desorb the water from the bed as water vapor 232. This water vapor 232 then passes through a heat-exchanger (HE) 240 to condense 242 into drinking water which is collected in a tank 250. The process of adsorption-desorption continues. After that, water from the coils 234 goes back to mixed with the raw water from the well.

The brine water 227 from the vacuum tank 220 will pass to the membrane distillation (MD) 260 and before entering the MD, this brine water will gain energy from the heat exchanger and increase the brine water temperature. Then, the hot water brine 242 is passed to the crystallizer 270.

In the membrane distillation process, PVDF is used as porous hydrophobic membrane. It performs the separation between water and dissolved minerals. The water feed, hot brine 242, is brought into contact with one side of the membrane. On the membrane permeate side, fresh water is collected in a continuous manner and stored in the drinking water tank 250. For membrane distillation crystallization system, the MD circuit is coupled with a crystallizer 270. A concentrated MD retentate stream is returned to the crystallizer 270 and water from the crystallizer 274 recirculated to be mixed with the water vapor 232 from the adsorption-desorption unit 230.

### Example 2

Referring to FIG. 3, the adsorption-desorption unit has two columns. The system is operated as described above for Example 1. The columns are continually switched between adsorption and desorption, in an alternate manner. For example, when desorption is started in the first column, adsorption is started in the second column. In this example, water exiting from the coils of the two columns 334 are combined and fed back at the entry of the system. An external energy source 390 may be used to heat this water, if its temperature has decreased. Such energy source is preferably solar energy 392 using ultra high concentrator photovoltaic (UHCPV). Also in this example, water vapor exiting the columns 332 is combined prior to being directed to the heat-exchanger.

As will be understood by a skilled person, the process and associated system of this disclosure presents various advantages as outlined above. In addition, brine disposal is becoming a huge problem as a consequence of the extensive application of reverse osmosis technology for desalination purposes. The process of this disclosure leads to a solid waste which, as outlined above, may be used in the recovery of heavy metals in water. The process also allows for the treatment of water with high concentrations of non-volatile solutes.

Although the present embodiments have been described with reference to specific example embodiments, it will be evident that various modifications and changes may be made to these embodiments without departing from the broader spirit and scope of the various embodiments.

This disclosure refers to a number of documents, the content of which is herein incorporated by reference in their entirety.

### INDUSTRIAL APPLICABILITY

The operating temperatures in the process of this disclosure may be maintained at a temperature as low as 50° C., and the operating pressure is around the natural atmospheric pressure (equal to about 1 bar). Also, in the case of a deep well, the energy source is the natural energy source from the water. Accordingly, the process is energy-efficient and cost-effective. Use of a heat-exchanger (instead of a condenser) enhances the cost-efficiency of the process of this disclosure. The process of this disclosure may be implemented in a plant or system with a piping that is made thin, since the required pressure is low. Accordingly, the production cost of the plant is also low comparing to a plant for RO. In addition, the process does not require use of cartridge filter, nanofilter, high pressure pumps or the like.

The specification and drawings are to be regarded in an illustrative rather than a restrictive sense.

What is claimed is:

1. A process for treating well water, comprising:
(a) submitting well water to a vacuum tank process to obtain water vapor and brine;
(b) submitting the water vapor to adsorption and desorption processes in an adsorption-desorption unit having one or more columns;
(c) submitting the water vapor from step (b) to a heat-exchange process to obtain the drinking water and brine, wherein heat is exchanged between the water vapor and brine obtained from step (a); and
(d) submitting brine obtained from steps (a) and (c) to a membrane distillation-crystallization process to obtain drinking water and a solid waste, the drinking water being combined to the drinking water obtained at step (c).

2. The process of claim 1, further comprising a step of (al) adding an anti-scalant to water prior to step (a).

3. The process of claim 1, wherein the well is a deep well and the well water at step (a) has a temperature of about 60 to 90° C.

4. The process of claim 1, wherein the well is a regular well and the well water is heated prior to step (a), optionally heating is performed with solar energy.

5. The process of claim 1, wherein at step (b) the water vapor is adsorbed on a hydrophilic adsorbent.

6. The process of claim 1, wherein step (b) comprises simultaneously sparging air during the adsorption process.

7. The process of claim 1, wherein at step (b), the water vapor is desorbed from a hydrophilic adsorbent by passing the well water into coils of the column, and the process comprises the further step of (b1) mixing the water from the coils with the well water; optionally the water from the coil is heated to about 60 to 90° C. prior to being mixed with the well water, and optionally heating is performed with solar energy.

8. The process of claim 1, wherein step (d) comprises contacting one side of a porous hydrophobic membrane with brine, while contacting the other side of the membrane with water at room temperature which is tap water or the drinking water obtained at steps (c) and (d).

9. The process of claim 1, further comprising a step of (e) submitting the drinking water to a cooling step.

10. The process of claim 1, wherein step (b) is performed simultaneously in two or more columns of the adsorption-desorption unit, the water vapor obtained from the units being combined prior to step (c).

11. A process for treating deep well water, comprising:
(a) pumping water from a deep well and submitting the water to a vacuum tank process to obtain water vapor and brine;
(b) submitting the water vapor to adsorption and desorption processes in an adsorption-desorption unit having one or more column comprising a hydrophilic adsorbent and coils, wherein the water vapor is adsorbed on a hydrophilic adsorbent and the water vapor is desorbed from the hydrophilic adsorbent by passing the well water into the coils;
(c) submitting the water vapor from step (b) to a heat-exchange process to obtain the drinking water and brine, wherein heat is exchanged between the water vapor and brine obtained from step (a);
(d) submitting brine obtained from steps (a) and (c) to a membrane distillation process to obtain drinking water and salt water, the drinking water being combined to the drinking water obtained from step (c), wherein one side of a porous hydrophobic membrane is contacted with brine, while the other side is contacted with water at room temperature which is tap water or the drinking water obtained from steps (c) and (d); and
(e) submitting the salt water to a crystallization step to obtain a solid waste and water vapor, and the water vapor is mixed with the water vapor obtained from step (b).

12. A system for well water treatment, comprising:
a vacuum tank;
an adsorption-desorption unit having one or more columns;
a heat-exchanger; and
a membrane distillation-crystallization unit,
wherein the vacuum tank is operably connected to a well such that water from the well at a temperature of about 60 to 90° C. fed thereto yields brine and water vapor which is fed to the adsorption-desorption unit, and the water vapor exiting the adsorption-desorption unit is fed to the heat-exchanger wherein heat is exchanged between the water vapor and brine from the vacuum tank yielding a condensate drinking water which is collected in a collector tank and brine which is fed to the membrane distillation-crystallization unit to yield a solid salt waste and water vapor which is fed back to the heat-exchanger.

13. The system of claim 12, wherein the one or more columns each comprises a hydrophilic adsorbent and coils.

14. The system of claim 12, a distillation membrane in the membrane distillation-crystallization unit is a porous hydrophobic membrane.

15. The system of claim 12, further comprising at least one heater located between the well and the vacuum tank and/or between an exit from coils of the column and a point of entry of the well water in the system; optionally the at least one heater uses solar energy.
